(19) United States
(12) Patent Application Publication
(10) Pub. No.: US 2015/0091721 A1
(43) Pub. Date: Apr. 2, 2015

(54) SIGNAL LEVEL MONITORING SYSTEM THAT MINIMIZES FALSE ALARMS

(71) Applicant: Victor M. Zinevich, Voronezh (RU)

(72) Inventor: Victor M. Zinevich, Voronezh (RU)

(21) Appl. No.: 14/044,809

(22) Filed: Oct. 2, 2013

(51) Int. Cl. G08B 29/02

(52) U.S. Cl. CPC G08B 29/02
USPC 340/507

(57) ABSTRACT

A system for monitoring signal level of a signal in a communications network, comprising a monitor that includes (i) a receiver to receive the signal from the network, (ii) a detector for detecting signal level values of the signal, and (iii) a sensor for sensing temperatures at the monitoring point in association with the signal level values. The system further comprises (i) means for evaluating the signal level values relative to an alarm reference, (ii) means for issuing alarms based on an alarm criterion defined in terms of the signal level values and the alarm reference, (iii) means for deriving an empirical relationship between signal level and temperature from the signal level values and temperatures, and (iv) means for adjusting the alarm criterion in accordance with the empirical relationship, such that temperature-dependent variations of signal level are substantially accounted for in issuing alarms.

### BACKGROUND OF THE INVENTION

1. Field of Invention

The present invention relates generally to monitoring parameters or metrics of signals transmitted in communications networks, and more particularly to a system and method for minimizing false alarms resulting from temperature-dependent variations in signal level in communications networks.

2. Background Art

In communications networks, such as wire, cable, or wireless networks, or a combination of wire, cable and/or wireless, there is a desire (or in some cases a necessity) to monitor signals being transmitted in the networks or monitor electrical and other physical properties or parameters of devices connected in the network. To accomplish these functions, monitoring or measurement apparatus are employed or installed at either or both ends of the communications network and/or distributed along the network at various points. Such apparatus may measure, store and report certain signal parameters such as, for example, signal level, signal-to-noise ratio (SNR), carrier-to-noise ratio (CNR), bit-error-rate (BER), modulation error rate (MER), FEC codeword error rate, phase lock loop (PLL) lock, quantization noise (QN), maximum amplitude variation across a channel, and the like. Such apparatus (or remote controllers they communicate with) may also issue an alarm or warning signal when a particular signal parameter attains or exceeds or fails to attain or exceed a threshold, or deviates beyond a limit (i.e., an “alarm limit”) above or below a predetermined standard reference value (e.g., an initial, expected or average value). Examples of such monitoring or measurement apparatus are disclosed in the following patent documents: U.S. Pat. App. Pub. 2010/0299713 to Salinger et al.; U.S. Pat. App. Pub. 2007/0288982 to Donahue; U.S. Pat. App. Pub. 2007/0133425 to Chappell; U.S. Pat. App. Pub. 200510226161 to Jaworski; U.S. Pat. App. Pub. 2004/0103442 to Eng; U.S. Pat. No. 6,880,170 to Kauffman et al.; and U.S. Pat. No. 7,003,414 to Wichelman et al. In some cases, such apparatus, in addition to or instead of reporting an alarm or signal measurements, may trigger an action based on a signal parameter, e.g., exceeding a threshold or an alarm limit. The triggered action may be, for example, blocking transmission of or attenuating signals, or switching the transmission of signals to another channel or channels. Examples of such apparatus include a dynamic ingress arrester and a communications gateway disclosed in U.S. Pat. App. Pub. 2007/0288982 and U.S. Pat. No. 6,880,170, respectively. For the purpose of this application, including the claims, the monitoring apparatus disclosed in the patent documents cited in this paragraph are considered “monitors” or “monitoring systems.” However, the term “monitor” or “monitoring systems” are not limited to these apparatus or types of apparatus.

As indicated, one possible function of a monitoring system is to issue an alarm or warning when a particular signal parameter attains or exceeds, or fails to attain or exceed, a threshold, or deviates beyond an alarm limit. In one embodiment, the alarm may be generated by the monitor itself and transmitted as an information signal over the communications network (or a secondary network) to a central location or other remote location (relative to the monitor). The central or other remote location may include a programmed controller, microprocessor, computer-server, or other processor (“remote controller”), which receives the alarm signal, records the alarm, displays the alarm, and/or generates an alarm communication to appropriate personnel. In an alternative embodiment, the alarm may be generated by the remote controller in response to measured data transmitted to it from the monitor (or monitors). In either case, the alarm alerts personnel to a problem in the network. By identifying the monitor that issued the alarm (as in the former case) or that sent the measured data (as in the latter case), the location of the problem can be identified or at least approximated. Network technicians may prioritize their repair and maintenance work based on alarms or take immediate action to correct the problem. Thus, if an alarm is issued when a network problem does not actually exist (i.e., a “false alarm”), unnecessary time and expense may be incurred. In some implementations, alarms may cause the monitor to modify its operation, change operating frequencies, attenuate or block transmissions, etc., in an attempt to avoid or diagnose a perceived network problem. Thus, false alarms have consequences. They may lead to unnecessary modification or curtailment of the operation of communications networks and monitors and reduce their effectiveness.

One cause of a false alarm for signal level measurements and other measurements of parameters based on signal level, is temperature-dependent variations in gain and/or attenuation in the communications network. The attenuation of most RF network cables varies as a function of temperature. For example, the attenuation of coaxial cables varies by about 1% per 10 degrees Fahrenheit (F), where the attenuation increases with increased temperature and decreases with decreased temperature. The losses in passive network devices and the gain of amplifiers also vary with temperature. Amplifiers are designed to compensate for temperature effects by open-loop thermal compensation or closed-loop automatic gain control (AGC). In each case, the gain of the amplifier is adjusted to regulate output signal level against temperature dependent increases or decreases in network losses and gain. However, such temperature compensation is not perfect. The gain adjustment in the open-loop method is based on only an approximation of the variations in losses due to temperature. In the AGC method, signal level variations due to temperature may exceed the dynamic range of the AGC loop. Thus, even with amplifier compensation, there still may be significant variations in signal level as a function of temperature.

The degree and character of signal level variations due to temperature are usually specific for each point in the network being monitored (“monitoring point”). The variation behavior depends, in large part, on whether there are long runs of cable, passive network devices and/or amplifiers in the vicinity of the monitoring point. For example, a monitoring point may not have a compensating amplifier nearby and/or may follow a long run of coaxial cable, and thus a relatively wide variation in signal level due to temperature would be expected. Another monitoring point may be near a compensating amplifier, and thus a smaller variation in signal level due to temperature would be expected. The surroundings of the monitoring point may also affect signal level behavior. For example, underground or enclosed points of the network may experience smaller or larger temperature swings than exposed points and thus experience smaller or larger signal level variations, respectively. Again, it is this temperature-dependent variation of signal level that can trigger false alarms. Therefore, an effective approach to the problem is one that recognizes that corrective action should be tailored or individualized for each monitoring point requiring attention.

Efforts to create thresholds, reference levels for alarms, and alarm limits that are more empirical than nominal or arbitrary are in use. For example, a monitoring probe called f-Scout™, supplied by Arcom Digital, LLC, Syracuse, N.Y., regularly collects signal level measurement data in a coaxial cable network and, once a history of measurements is acquired, the data is averaged to create standard reference levels from which alarm limits are defined. Other monitors that may average measurement data to create empirically-derived thresholds are described in U.S. Pat. No. 6,880,170 to Kauffman et al.; U.S. Pat. No. 7,003,414 to Wichelman et al.; and U.S. Pat. App. Pub. 2010/0299713 to Salinger et al. While such empirically-derived signal level thresholds and standard reference levels are more accurate than nominal values, some may still yield false alarms due to the temperature effects discussed above. The averaging of historical data may not be enough to account for the potential swings in signal level due to temperature. Such temperature-dependent swings may be large enough to overcome an averaged value.

Therefore, a need exists for minimizing or eliminating temperature-related false alarms associated with monitoring signal level (or other parameters based on signal level) in communications networks.

### OBJECTS AND SUMMARY OF THE INVENTION

It is therefore an object of the present invention to provide a network monitoring system and method that overcomes the problems associated with the prior art and fulfills the aforementioned need.

It is another object of the present invention to provide a monitoring system and method that minimizes false alarms caused by temperature-dependent variations of signal level in a communications network.

It is a further object of the present invention to provide a monitoring system and method employing a criterion for issuing an alarm (“alarm criterion”), where the alarm criterion is adjustable based on temperature-dependent variations of signal level (“temperature-dependent adjustment”).

It is still another object of the present invention to provide a monitoring system and method where the temperature-dependent adjustment of the alarm criterion is tailored or individualized for each point being monitored in the communications network.

It is still a further another object of some embodiments of the present invention to provide a monitoring system and method employing a threshold, a standard reference level, or a deviation from a reference level (any one referred to as “an alarm reference”), where the alarm reference is adjustable based on temperature-dependent variations of signal level.

It is yet another object of the present invention to provide a monitoring system and method that derives an empirical relationship between signal level and temperature at a particular monitoring point and performs a temperature-dependent adjustment of the alarm criterion in accordance with the empirical relationship.

In accordance with one embodiment of the present invention, there is provided a monitoring system for monitoring the signal level of a signal at a monitoring point in a communications network. The system comprises a monitor configured to be coupled to the monitoring point. The monitor includes (i) a receiver tuned to receive the signal from the monitoring point, (ii) a detector for detecting values of signal level of the signal at the monitoring point, and (iii) a temperature sensor for sensing temperatures at the monitoring point in association with the detection of the signal level values. The system further comprises (i) means for evaluating the signal level values relative to an alarm reference, (ii) means for issuing alarms based on an alarm criterion defined in terms of the signal level values and the alarm reference, (iii) means for deriving an empirical relationship between signal level and temperature from the signal level values and temperatures, and (iv) means for adjusting the alarm criterion in accordance with the empirical relationship. The alarm criterion is adjusted such that temperature-dependent variations of the detected signal level values are substantially accounted for in issuing the alarms.

In another embodiment, a monitoring system monitors a signal level parameter of the signal at the monitoring point in the communications network. The signal level parameter may be signal level or another parameter related to signal level, such as signal-to-noise ratio or carrier-to-noise ratio. The system comprises a monitor configured to be coupled to the monitoring point. It includes (i) a receiver tuned to receive the signal from the monitoring point, (ii) a detector for detecting values of signal level of the signal at the monitoring point, and (iii) a temperature sensor for sensing temperatures at the monitoring point in association with the detection of the signal level values. The system further comprises (i) means for determining values of the signal level parameter based on the detected signal level values, (ii) means for evaluating the signal level parameter values relative to an alarm reference, (iii) means for issuing alarms based on an alarm criterion defined in terms of the signal level parameter values and the alarm reference, (iv) means for deriving an empirical relationship between signal level and temperature based on the signal level values detected and the temperatures sensed at the monitoring point, and (f) means for adjusting the alarm criterion in accordance with the empirical relationship. The alarm criterion is adjusted such that temperature-dependent variations of the signal level parameter values are substantially accounted for in issuing the alarms.

A method of monitoring the signal level of a signal at a monitoring point in a communications network is also a part of the present invention. In one embodiment, the method comprises the steps of: (a) receiving the signal from the monitoring point; (b) detecting values of the signal level of the signal at the monitoring point; (c) sensing temperatures at the monitoring point in association with the detection of the signal level values; (d) evaluating the signal level values relative to an alarm reference; (e) issuing alarms based on a criterion defined in terms of the signal level values and the alarm reference; (i) deriving an empirical relationship between signal level and temperature based on the signal level values detected in step (b) and the temperatures sensed in step (c): and (g) adjusting the criterion in accordance with the empirical relationship, such that temperature-dependent variations of the signal level values are substantially accounted for in issuing alarms.

In another method of the present invention, a signal level parameter of a signal is monitored at a monitoring point in a communications network. In one embodiment, the method comprises the steps of: (a) receiving the signal from the monitoring point; (b) detecting values of signal level of the signal at the monitoring point; (c) sensing temperatures at the monitoring point in association with the detection of the signal level values; (d) determining values of the signal level parameter based on the signal level values; (e) evaluating the signal level parameter values relative to an alarm reference; (f) issuing alarms based on a criterion defined in terms of the signal level parameter values and the alarm reference; (g) deriving an empirical relationship between signal level and temperature based on the signal level values detected in step (b) and the temperatures sensed in step (c); and (h) adjusting the criterion in accordance with the empirical relationship, such that temperature-dependent variations of the values of the signal level parameter are substantially accounted for in issuing alarms.

In one embodiment, the empirical relationship between signal level and temperature is derived in accordance with a method comprising the steps of: (1) detecting a plurality of signal level values of the signal at the monitoring point, over a first time period; (2) sensing a plurality of temperatures at the monitoring point in association with the detection of the plurality of signal level values; (3) starting with an initial relationship between signal level and temperature; (4) determining a first relationship between signal level and temperature based on the plurality of signal level values and the plurality of temperatures obtained over the first time period; (5) averaging together the initial relationship and the first relationship to create a first average relationship; (6) repeating steps (1) and (2) over a second time period and repeating step (4) to determine a second relationship between signal level and temperature based on the plurality of signal level values and the plurality of temperatures obtained over the second time period; (7) averaging together the second relationship and the first average relationship to create a second average relationship; and (8) successively repeating steps (6) and (7) for successive time periods, respectively, to determine successive relationships and create successive average relationships, respectively, until the empirical relationship is derived.

In another embodiment, the empirical relationship is derived in accordance with another method, comprising the steps of: (1) detecting a plurality of signal level values of the signal at the monitoring point, over a first time period; (2) sensing a plurality of temperatures at the monitoring point in association with the detection of the plurality of signal level values; (3) determining a first relationship between signal level and temperature based on the plurality of signal level values and the plurality of temperatures obtained over the first time period; (4) successively repeating steps (1), (2) and (3) for successive time periods, respectively, to determine successive relationships; and (5) averaging together the first relationship and the successive relationships to derive the empirical relationship.

### BRIEF DESCRIPTION OF THE DRAWING

Further objects of the present invention will become apparent from the following description of a preferred embodiment with reference to the accompanying drawing, in which:

FIG. 1 is a block diagram of one example of a communications network employing an exemplary embodiment of a monitoring system of the present invention;

FIG. 2 is a block diagram of one embodiment of a monitor of the monitoring system of the present invention;

FIG. 3 is a block diagram of another embodiment of a monitor of the monitoring system of the present invention;

FIG. 4 is a block diagram of one embodiment of a controller of the monitoring system of the present invention;

FIG. 5 is a flow diagram illustrating steps of an exemplary method of the present invention;

FIG. 6 is a flow diagram of steps of an exemplary method of deriving an empirical relationship between signal level and temperature, in accordance with the present invention;

FIGS. 7-10 are a series of graphs further illustrating the method steps of FIG. 6;

FIG. 11 is a graph of an empirical relationship for a particular monitoring point at a particular television channel, where a reference level of the signal level is defined at zero degrees;

FIG. 12 is a graph showing the reference level at zero degrees and an alarm reference, and further showing temperature-dependent variations of the reference level at two different temperatures and corresponding adjustments of the alarm reference;

FIG. 13 is a graph of an empirical relationship identical to the one in FIG. 11, except that the reference level of the signal level is defined at 68 degrees:

FIG. 14 is a graph showing the reference level at 68 degrees and two alarm references, and further showing temperature-dependent variations of the reference level and corresponding adjustments of the alarm reference; and

FIG. 15 is a graph of another empirical relationship characterized by two gradients.

### DETAILED DESCRIPTION OF THE PREFERRED EMBODIMENT

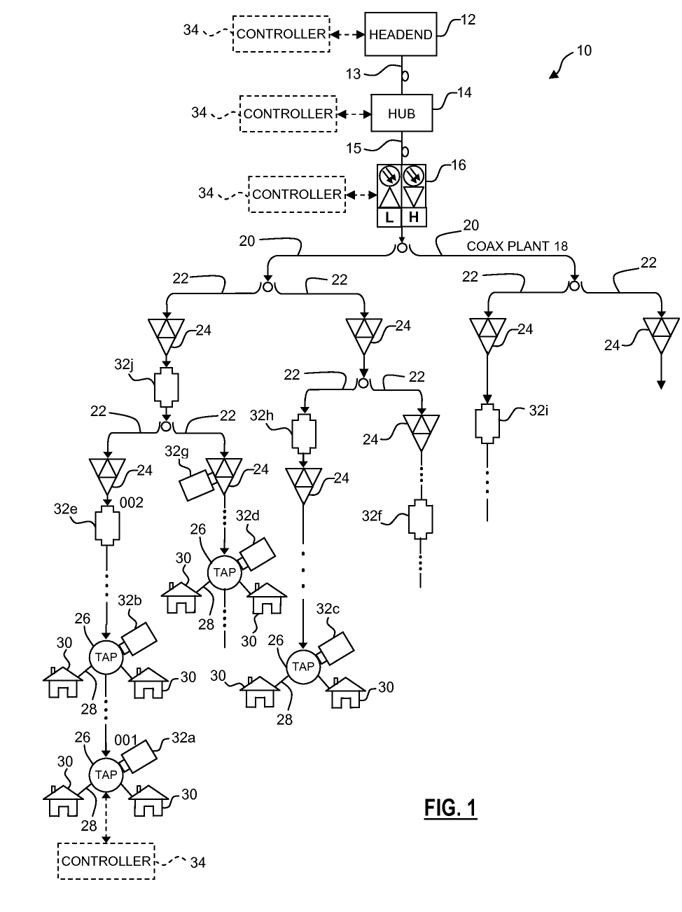

Referring to FIG. 1, there is shown a communications network 10, which, for illustrative purposes only, is a bi-directional cable television, hybrid fiber-coax (HFC) network. Network 10 typically includes a headend 12, a hub 14, one or more fiber optic nodes 16, and a coaxial cable plant 18. Cable plant 18 includes coaxial trunk cables 20, coaxial feeder cables 22, bi-directional amplifiers 24, multi- or subscriber taps 26, and drop coaxial cables 28. Drop cables 28 connect a number of subscribers 30 to network 10. Headend 12 typically includes modulators for producing multiple RF cable television signals and optical transmitters (not shown) for converting the RF television signals to optical television signals. The optical television signals are transmitted downstream over optical fibers 13 to hub 14, where the signals are routed to multiple fiber optic nodes, including fiber node 16 via an optical fiber 15. The optical television signals are converted back to RF television signals by an optical receiver in node 16 and delivered to coaxial cable plant 18. The RF television signals flow downstream through plant 18 to subscribers 30. Subscriber-generated signals, including Internet data signals, telephone voice signals, on-demand control signals, other set-top box and modem signals, etc., are transmitted upstream through plant 18, from subscribers 30 to fiber node 16. Signal quality monitors (e.g., downstream, upstream and end-of-line monitors) distributed throughout network 10, also transmit data and other signals upstream. These upstream (subscriber-generated and monitor) signals are referred to as “RF return path signals.” The RF return path signals are converted to optical return path signals by an optical transmitter in node 16 and then transmitted via optical fiber 15 to hub 14. The optical return path signals then travel to headend 12 via optical fibers 13. Within headend 12, the optical return path signals are converted back to RF return path signals in an optical receiver (not shown). The RF return path signals are then received by appropriate receiving equipment. Further details of the construction and operation of network 10 are not provided here, because they are well-known in the cable television industry and to one of ordinary skill in the art.

Again referring to FIG. 1, a system for monitoring signal level parameters of signals in communications network 10 is shown. Here, the system includes at least one controller 34 and a number of signal monitors 32a, 32b, 32c, 32d, 32e, 32f, 32g. 32h, 32i, and 32j. In a simple embodiment, the system includes at least one monitor (e.g., monitor 32a) and one controller 34. Controller 34 may be coupled to network 10 at any appropriate location. Some locations are shown in FIG. 1. For example, controller 34 may be coupled to headend 12, hub 14, fiber optic node 16, or possibly at an end-of-line location. Monitors 32a to 32j are coupled to various monitoring points in network 10. A monitoring point may be any accessible test or tap point of network 10 or a network device forming a part of network 10 (e.g., a monitoring point 001 for monitor 32a). A monitoring point may be a direct in-line connection point along a feeder cable (e.g., a monitoring point 002 for monitor 32e). Further, a monitoring point may be at either end of a drop cable or at an end-of-line location. Also, a monitoring point could be a connection point inside a network device, such as a bi-directional line extender amplifier or a subscriber tap, where the monitor is contained within or integrated with the network device. In FIG. 1, monitors 32a to 32d are coupled to seizure screw ports of different multi-taps 26. Monitors 32a to 32d are configured with a threaded probe tip so they can be threaded into a seizure port of the multi-tap. An example of such a probe tip is shown in U.S. Pat. No. 8,458,759 (see, e.g., FIG. 4). Electrical contact is made between the monitor and a seizure screw (not shown) inside the seizure port of multi-tap 26. The seizure screw is, in turn, clamped to and in electrical contact with the center conductor of a feeder cable. Monitor 32g is similarly coupled to a bi-directional test port of amplifier 24. Monitors 32e, 32f, and 32h to 32j are connected in-line along feeder cables 22. Monitors 32e, 32f, and 32h to 32j may be configured with a seizure screw or ⅝ inch connectors to connect to cables 22. If a monitor is contained within or integrated with a network device, it would be configured with contacts, contact pads, traces, wires, connectors, couplers and/or other means for making electrical contact with the network device or the feeder cable connected to the network device.

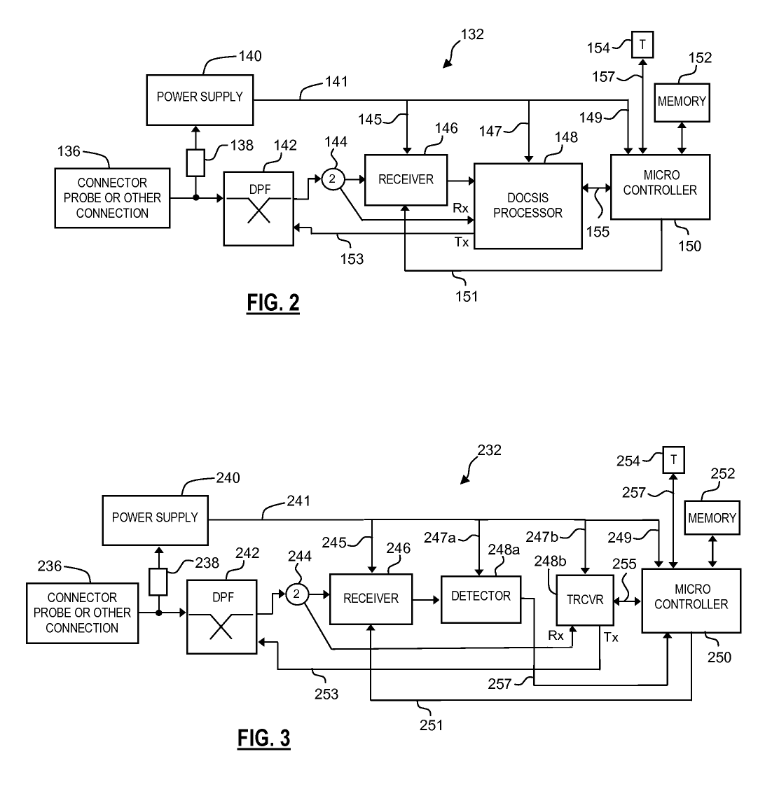

In some embodiments, controller 34 (or its function) is contained (or programmed) within monitors 32a to 32j, and forms a part of each monitor. In such case, each monitor functions as a monitoring system and bi-directional communications may be established between such monitors and a master controller or other communications device via network 10 or a wireless network. In other embodiments, controller 34 may be implemented partially in a remote device and partially within each of the monitors. Generally, monitors 32a to 32j will contain some form of controller to locally control the basic operation and functions of the monitors (see discussion regarding FIGS. 2 and 3). In those embodiments where controller 34 is separate and apart from monitors 32a to 32j, as shown in FIG. 1, bi-directional communications are preferably established between the monitors and controller 34 via network 10. Controller 34 is configured to be remotely positioned relative to monitors 32a to 32j, at their respective monitoring points, by virtue of its ability to function remotely from the monitors and to communicate and exchange information with the monitors. Controller 34 is associated with monitors 32a to 32j because it is configured to identify and address each of the monitors and communicate and exchange information with them. In the case where controller 34 is contained within or integrated with a monitor, the association is established by the controller's physical proximity and substantially exclusive service to the monitor. The details of connecting monitors to communications networks and of the communications between monitors and controllers are well-known in the industry and to one of ordinary skill in the art. For example, see U.S. Patent App. Pub. 2010/0299713 to Salinger et al.; U.S. Patent App. Pub. 2007/0133425 to Chappell; U.S. Patent App. Pub. 2005/0226161 to Jaworski; and U.S. Patent App. Pub. 2004/0103442 to Eng, the disclosures of which are incorporated herein by reference.

Referring now to FIG. 2, there is shown a monitor 132 configured in accordance with one embodiment of the present invention. Monitor 132 includes a coupling mechanism 136, which may be a coaxial or other connector, a probe tip for coupling to a seizure or other port, a simple conductor or contact, or the like. Coupling mechanism 136 provides a means for connecting or otherwise coupling monitor 132 to a monitoring point in network 10. It is desired that the monitoring point be at a point in network 10 that contains AC power (e.g., 90 volts AC, 60 Hz). The monitoring point may be inside or otherwise associated with a network device (e.g., a subscriber tap, line extender or power supply). AC power is received through coupling mechanism 136 and tapped by an RF choke, ferrite bead, lowpass filter, or other power passing means 138, as is well-known. The AC power is then received in a power supply 140. Power supply 140 converts the AC power to rectified DC power and generates therefrom one or more regulated DC voltages for powering the active components of monitor 132. The RF television signals transmitted downstream on network 10 are also received through coupling mechanism 136 and pass through a highpass filter leg of a bi-directional diplexer 142. The RF television signals are power divided in a signal splitter 144, which has two outputs. The RF television signals are presented at the two outputs and carried to a wideband tunable receiver 146 and a DOCSIS cable downstream/upstream processor 148, respectively. Receiver 146 includes a wideband tuner that can tune to and selectively receive an RF television signal of any one of a number of television channels. Receiver 146 is tuned to a particular channel in response to a control signal or instructions received from a microcontroller 150, via a control line or communications bus 151. Receiver 146 may also include a bandpass filter (not shown) to filter out-of-band spurious signal products from the tuning process. Receiver 146 is powered by a DC voltage (e.g., +3.3 volts) supplied by power supply 140 via an electrical path 141/145.

The RF television signal of a channel selected by receiver 146 is received by DOCSIS downstream/upstream processor 148 via a first input. The RF downstream signals of all of the channels (from splitter 144) are received by processor 148 via a second or Rx input. Processor 148 contains an “out-of-band” receiver (not shown) for receiving the latter signals from the Rx input. RF modulated control signals, data (e.g., configuration data), and/or programming instructions are transmitted downstream from controller 34 and are demodulated by the out-of-band receiver. The control signals, data and/or programming instructions are used to control the operation of, program, and/or reconfigure processor 148 and microcontroller 150. Processor 148 prepares data for transmission and transmits data and other information upstream in network 10. Upstream signals are transmitted from a Tx output of processor 148 to bi-directional diplexer 142, via a communications line 153. The typically lower-frequency upstream signals pass through a lowpass filter leg of diplexer 142 and then pass through coupling mechanism 136. The upstream signals then travel upstream in network 10 to controller 34 (or other server) on an upstream frequency band. Processor 148 is powered by a DC voltage (e.g., +3.3 volts) supplied by power supply 140 via an electrical path 141/147. Processor 148 may be a DOCSIS PHY/MAC sub-processor as disclosed in U.S. Patent App. Pub. 2010/0299713, the description of which is incorporated herein by reference. Certain operations of processor 148 are controlled by microcontroller 150 via a communications bus or other interface 155. Microcontroller 150 utilizes a memory unit 152, which contains read/write flash memory and may also contain RAM and known types of ROM memory. Data and other information may be exchanged between processor 148 and microcontroller 150 via interface 155. Microcontroller 150 is powered by a DC voltage (e.g., +3.3 volts) supplied by power supply 140, via an electrical path 141/149.

A temperature sensor 154 is connected to microcontroller 150 via a bi-directional data line 157 and derives its power from data line 157 (i.e., parasitic power). Sensor 154 may be a DS18S20-PAR, 1-Wire® Parasite-Power Digital Thermometer, manufactured by Maxim Integrated Products, Inc., San Jose, Calif. Sensor 154 senses the ambient temperature of monitor 132 and provides temperature measurements with a 9-bit resolution, Sensor 154 is addressed and controlled by microcontroller 150 via data line 157, and temperature measurements are read from sensor 154 by microcontroller 150. The measurements are delivered from sensor 154 to microcontroller 150 via data line 157.

Processor 148 includes (1) an analog-to-digital (A/D) converter to digitize the RF television signal of the selected channel, (2) a demodulator (e.g., a QAM demodulator) to demodulate the digitized RF television signal, and (3) a detector for detecting the signal level of the demodulated or baseband version of the television signal. Additionally, processor 148 may include an RMS detector for detecting the signal level directly from the RF television signal. In the latter case, the signal level of at least two frequencies of the RF television signal is detected. In either case, processor 148 carries out repeated detections of the signal level to produce multiple values of signal level, which are then further processed and/or stored. The values of signal level detected over a particular period of time may be averaged to produce averaged signal level values. Signal level values are detected for all or some of the television channels, depending on channel tuning instructions stored in microcontroller 150. These instructions may be preprogrammed in microcontroller 150 or user selected at controller 34 and communicated to monitor 132 via network 10. Typically, microcontroller 150 will run through a scan routine, causing receiver 146 to tune sequentially through all or a select group of TV channels and causing processor 148 to detect signal level values for each of those channels. The signal level values may be buffered in processor 148 until read by microcontroller 150 or synchronously transported to processor 148. The signal level values are transported to microcontroller 150, via bus 155. In microcontroller 150, the signal level values are associated in time with temperature data. Processor 148 may timestamp the detected signal level values or averaged signal level values (hereinafter, collectively, “signal level values”), which may aid in associating the signal level values with temperatures sensed by sensor 154.

Sensor 154 senses the ambient temperature of monitor 132 at pre-determined time intervals. The temperatures may be measured as often as the signal level values are detected by processor 148, so there is a literal time correspondence between the two sets of data. However, ambient temperature remains fairly constant over relatively extended periods of time; thus, in certain applications, it is not necessary to measure temperature every instant that a signal level is detected. When sensor 154 produces a temperature measurement or a set of measurements (stored in a buffer in sensor 154), microcontroller 150 requests a transfer of the measurements (or temperatures) to microcontroller 150. Microcontroller 150 is programmed to apply a timestamp to the temperature measurements and, based on this timestamp, the measurements are associated in time with the time stamped signal level values received from processor 148. The signal level values may be time stamped in microcontroller 150, rather than in processor 148. The present invention is not limited to using timestamps to associate the signal level values with the temperatures. Other known methods of association may be used, including simply linking a set of signal level values with a temperature measurement taken close enough in time to the detection of the set of signal level values. In the latter case, e.g., the set of signal level values are transferred to microcontroller 150 without a significant delay, and the current temperature measurement is read from sensor 154 and applied to that set of signal level values.

Processor 148 also measures the noise floor of the selected television channel received from receiver 146. From the noise floor measurements and detected signal level values, processor 148 or microcontroller 150 can determine other signal level parameters. For example, processor 148 or microcontroller 150 may determine signal-to-noise ratio or carrier-to-noise ratio. These other signal level parameters are then associated with a temperature measurement or measurements, in a similar manner as described above with respect to signal level values.

Once a channel scan routine has been executed by microcontroller 150, and signal level data or signal level parameter data have been collected for all selected channels, and the data have been associated with temperature measurements, the data is stored in the flash memory of memory unit 152 until called and transmitted to controller 34. A set of signal level data for a particular channel, along with an associated timestamp and temperature measurement, is collectively referred to as a “data set.” Preferably, controller 34 will address or poll each monitor in network 10 according to a preprogrammed or user-selected schedule and sequence. In FIG. 2, the controller's request for data will be received by processor 148, at the Rx input. The request will be either relayed to microcontroller 150 or a new command will be generated by processor 148 and sent to microcontroller 150, via bus 155. Microcontroller 150 will then retrieve the data sets (for the selected channels) from memory unit 152 and deliver them to processor 148. Processor 148 will then generate a data packet or packets (containing the data sets) according to the DOCSIS MAC protocol and modulate the packet(s) (e.g., 64-QAM modulation) to create an RF return path signal for transmission to controller 34. The RF return path signal (containing the DOCSIS MAC protocol data packet(s)) exits output Tx of processor 148 and enters diplexer 142 via communication line 153. The return signal then passes through the lowpass filter leg of diplexer 142 and enters network 10 through coupling mechanism 136. Of course, if controller 34 is downstream of monitor 132, the signal is prepared for downstream transmission.

Microcontroller 150 is configured to perform its operations by way of, e.g., a software program stored in memory unit 152 or firmware programmed in a ROM of memory unit 152. These operations may also be implemented in a field programmable gate array, digital signal processor, or application specific integrated circuit, in place of or alone with microcontroller 150. In addition, controller 34 may send instructions, software and configuration data to microcontroller 150, via processor 148, to reprogram or reconfigure the operations of microcontroller 150.

Referring now to FIG. 3, there is shown an alternative embodiment of the monitor—a monitor 232. The front end components of monitor 232, such as coupling mechanism 236, power tapping means 238, power supply 240, diplexer 242, signal splitter 244, and receiver 246, are identical in construction and operation to the corresponding components of monitor 132. In addition, the connection to network 10 and the reception of line power and RF downstream signals from network 10 are the same for monitor 232 as with monitor 132. The primary difference of monitor 232 from monitor 132 is that a DOCSIS cable downstream/upstream processor is replaced with an RMS detector 248a and a frequency shift key (FSK) transceiver 248b. FSK transceiver 248b also includes a down-converter (not shown) for converting signals to be transmitted upstream to an appropriate upstream center frequency (e.g., 20 MHz). Monitor 232 also includes a microcontroller 250, a memory unit 252, and a temperature sensor 254, which are essentially the same as the corresponding elements in monitor 132. The programming or configuration of microcontroller 250 is similar to microcontroller 150, except that microcontroller 250 will be programmed or configured to interface with and control FSK transceiver 248b. The tuning control of receiver 246 by microcontroller 250 is the same as in monitor 132. Receiver 246, detector 248a, FSK transceiver 248b, and microcontroller 250 are all powered by a DC voltage (e.g., +3.3 volts) supplied by power supply 240, via electrical paths 241/245, 241/247a, 241/247b, and 241/249, respectively.

Again referring to FIG. 3, the RF television signal of a channel selected by receiver 246 is received by RMS detector 248a and the signal level of at least two frequencies of the RF television signal is detected. The detected values of the signal level are then digitized in an A/D converter contained in detector 248a (not shown) and transferred synchronously to microcontroller 250, via a data bus 257. Alternatively, the signal level values are received as voltages at an input of microcontroller 250 that contains an A/D converter. The detector portion of detector 248a may be an AD8361 power detector with calibrated RMS response, manufactured by Analog Devices, Inc., Norwood, Mass. All of the RF downstream television signals (from splitter 244) are received by FSK transceiver 248b, via an Rx input. Transceiver 248b contains an FSK receiver tuned to a particular frequency band for receiving FSK modulated control signals, data (e.g., configuration data), and/or programming instructions transmitted from controller 34. These signals, data and programming instructions are demodulated in the FSK receiver and used to control the operation of, re-program, and/or reconfigure microcontroller 250. Transceiver 248b may be an ADF7020 FSK Transceiver manufactured by Analog Devices, Inc., Norwood, Mass., together with a down-converter circuit including, e.g., a KC3225A125.00 (125 MHz) clock oscillator by AVX Corp., Fountain Inn, S.C., a ADL5350 mixer by Analog Devices, Inc., Norwood, Mass., and a lowpass filter with a 20 MHz cutoff frequency.

Microcontroller 250 controls the operation of receiver 246, which in turn, controls the flow of signal level values (data) from detector 248a. Such data flow may be controlled by simply blocking the data into microcontroller 250. In this embodiment, microcontroller 250 is programmed (or otherwise configured) to control the collection of the signal level data, duration of signal level detection, and post processing of the data. This control function is essentially the same as in monitor 132. Other signal level parameters, such as signal-to-noise and carrier-to-noise ratio, may be measured in monitor 232 if receiver 246 is tune to receive the noise floor and detector 248a is able to detect the noise floor and produce noise-floor level data therefrom. As in monitor 132, monitor 232 detects signal level values for all or some of the television channels, depending on the channel tuning instructions from microcontroller 250. Again, such instructions may be preprogrammed in microcontroller 250 or user-selected at a remote controller and communicated to monitor 232 via network 10 or other communications network. Microcontroller 250 will run through a scan routine, causing receiver 246 to tune sequentially through all or a selected group of TV channels and causing detector 248a to detect signal level values for each of the channels.

Once the signal level values are received by microcontroller 250, they are associated with a timestamp and a current temperature measurement read from sensor 254. In this embodiment, detector 248a does not perform a time-stamping function. Sensor 254 senses the ambient temperature of monitor 232 and provides 9-bit resolution temperature measurements. Microcontroller 250 addresses sensor 254 and reads the temperature measurements via a data line 257. Microcontroller 250 reads the temperatures frequently enough so that it can associate a relatively current temperature with each set of signal level values. A data set, comprising a set of signal level values and an associated timestamp and temperature measurement, is stored in the flash memory of memory unit 252. Data sets for all selected channels in the scan routine are collected and stored in flash memory until called by and transmitted to controller 34.

Controller 34 polls monitor 232 according to a preprogrammed or user-selected schedule, requesting the data sets for a complete channel scan routine. The request will be received by FSK transceiver 248b, at the Rx input. The request will then be relayed to microcontroller 250 via bus 255. Microcontroller 250 will then retrieve the data sets from memory unit 252 and deliver them to transceiver 248b. The data sets will be FSK modulated in transceiver 248b and the resulting signal will be down-converted to a 20 MHz RF return path signal. The return path signal is then transmitted upstream in network 10 to controller 34. The RF return path signal (containing the data sets) exits the Tx output of transceiver 248b and enters diplexer 242 via communication line 253. The return signal passes through a lowpass filter leg of diplexer 242 and enters network 10 through coupling mechanism 236. The signal then travels upstream to controller 34. If controller 34 is downstream of monitor 232, the signal is prepared for a downstream transmission.

A modification to the monitor embodiment of FIG. 3 may be employed. The modification is that detector 248a is replaced with a downstream television signal demodulator chip, such as a QAM demodulator chip, that measures and provides signal level parameter data such as signal level and C/N or S/N ratio. The signal level parameter data is obtained from the demodulated television signal as in processor 148 of monitor 132. Such demodulator chips usually include an A/D converter so that signal level parameter data can be provided in digitized form. An example of such demodulator chip is an STV0297E QAM Demodulator IC with A/D converter, by STMicroelectronics, Santa Clara, Calif.

A block diagram of an embodiment of controller 34 is shown in FIG. 4. In this embodiment, controller 34 includes a transceiver 302 with a web interface board 304. Transceiver 302 is a DOCSIS protocol Cable Modem Termination System (CMTS) when monitor 132 (FIG. 2) is used and a FSK transceiver when monitor 232 (FIG. 3) is used. Transceiver 302 is connected to network 10 via a downstream output 306 and an upstream input 308. Transceiver 302 communicates with monitors 132 or 232 by transmitting signals downstream from output 306, and monitors 132, 232 communicate with transceiver 302 by transmitting signals upstream to input 308. Communications between a controller and multiple monitors in a cable television network are well-known and will not be further described here. Such communications are described in U.S. Patent App. Publication Nos. 2007/0133425 to Chappell, 2005/0226161 to Jaworski, and 2004/0103442 to Eng, which are incorporated herein by reference.

Web interface board 304 provides a gateway to the Internet or a LAN TCP/IP network 310. Network 310 provides the communications channel between transceiver 302 and a monitoring system server 312. A system database 314, a display 316, and a keyboard (including mouse) 318 are operatively connected to server 312. Server 312 contains an internal hard drive for storing software programs. The software programs provide a means to communicate with, control and reconfigure the monitors and to provide a graphics user interface via display 316 and keyboard 318. Other software or firmware is provided to process signal level data sets received from the monitors and to perform data analysis, including determining whether thresholds or limits have been reached or exceed and whether alarms should be issued. System database 314 contains a history of signal level data and related statistics for each monitor and may also contain maps of network 10 showing locations of the monitors and where signal level problems exits. Maps and statistics are displayed to the user on display 316. System server 312 also provides the user with an updated view (on display 316) of the downstream signal level at any monitoring point in network 10. The signal level data collection and processing operations of server 312 may be contained in the monitors themselves.

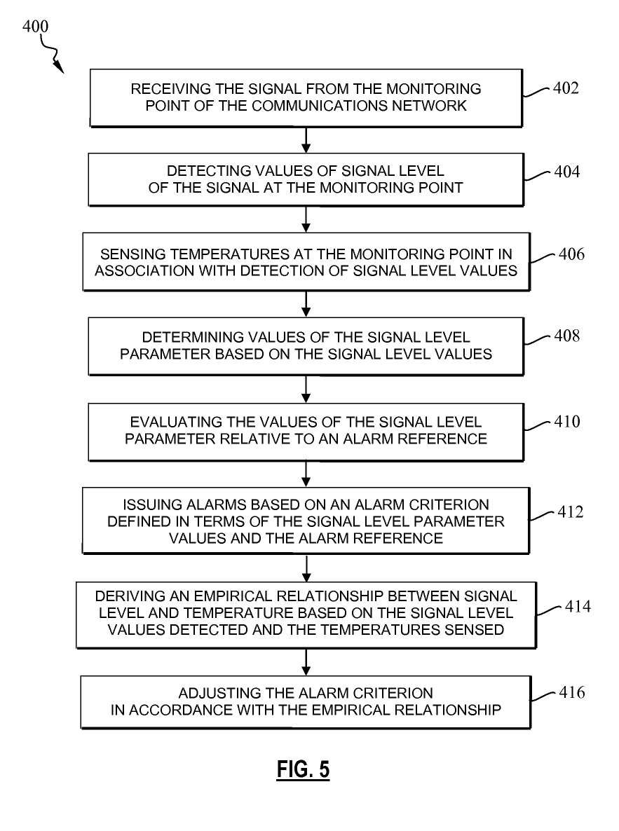

An object of the present invention is to take into account variations in signal level occurring in network 10 due to ambient temperature (temperature-dependent variations). For example, a rise in ambient temperature will cause coaxial cables 20, 22 and 28 (FIG. 1) to increase in attenuation, thus reducing the signal level of a signal traveling through these cables. The reduction in signal level could cause a threshold or a limit (from a reference level) to be exceeded, and thus cause an alarm to be triggered by a monitor or controller. The alarm would be triggered not because of any cable or equipment malfunction, or a noise condition, but because of changes due to temperature. It may be desirable to avoid triggering an alarm based on changes due to temperature. The present invention substantially accomplishes this objective by deriving an empirical relationship between signal level and temperature at each monitoring point equipped with a monitor. A method of accomplishing this objective is shown in the flow diagram of FIG. 5.

In FIG. 5, there is shown a method 400 of monitoring a signal level parameter (which may be just signal level) of a signal at a monitoring point in a communications network. Method 400 comprises steps 402 to 416. Step 402 concerns receiving the signal from the monitoring point. Step 404 concerns detecting values of signal level of the signal at the monitoring point. Step 406 concerns sensing temperatures at the monitoring point in association with the detection of the signal level values. Step 408 concerns determining values of the signal level parameter based on the signal level values. Step 408 is dispensed with if the signal level parameter is simply signal level. Step 410 concerns evaluating the values of the signal level parameter relative to an alarm reference. Step 412 concerns issuing alarms based on an alarm criterion defined in terms of the signal level parameter values and the alarm reference. Step 414 concerns deriving an empirical relationship between signal level and temperature based on the signal level values detected and the temperatures sensed. Lastly, step 416 concerns adjusting the alarm criterion in accordance with the empirical relationship, such that temperature-dependent variations of the signal level parameter values are substantially accounted for in issuing the alarms.

Once derived, the empirical relationship allows one to predict what the temperature-dependent variation in signal level will be for a given temperature (at a specific monitoring point). The predicted variation is used to determine an appropriate adjustment of the alarm criterion. An adjustment in the alarm criterion is preferably made by either adjusting the alarm reference or the signal level parameter values. For example, if the alarm reference is normally 3 dB below (i.e., −3 dB) a pre-determined or pre-selected reference level, and the predicted temperature-dependent variation is −5 dB, then an appropriate adjustment of the alarm reference would be at least −2 dB, to avoid dropping below the alarm reference and triggering an alarm (assuming no other variations). Preferably, the adjustment would be −5 dB, to correspond to the full temperature-dependent variation. Similarly, if the signal level parameter values are adjusted, they would be adjusted upward by at least 2 dB (+2 dB) and preferably 5 dB. Alternatively, the alarm criterion may be adjusted by adjusting both the alarm reference and the signal level parameter values.

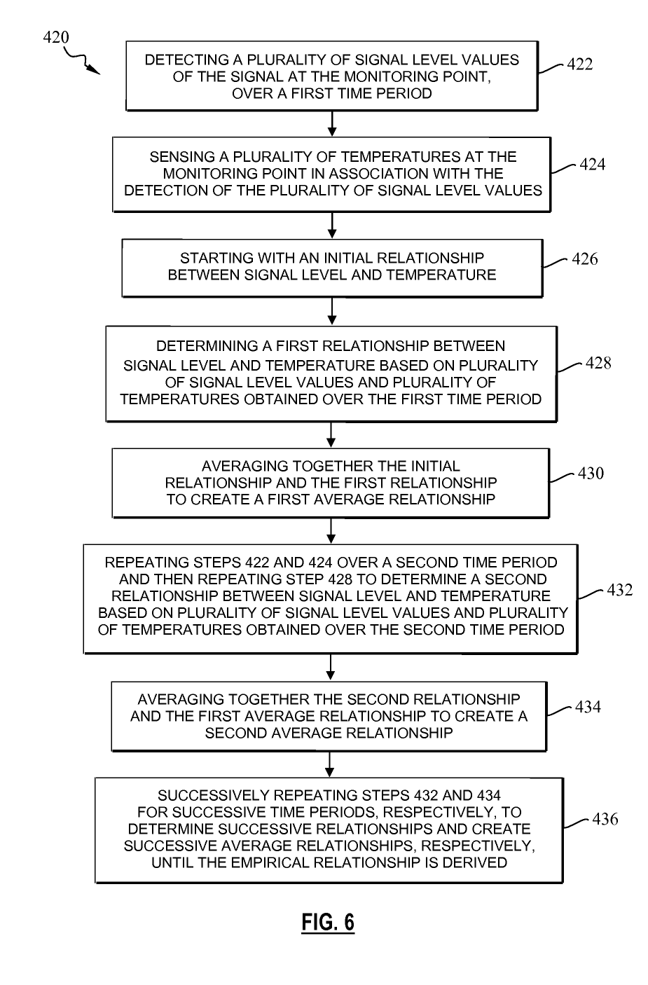

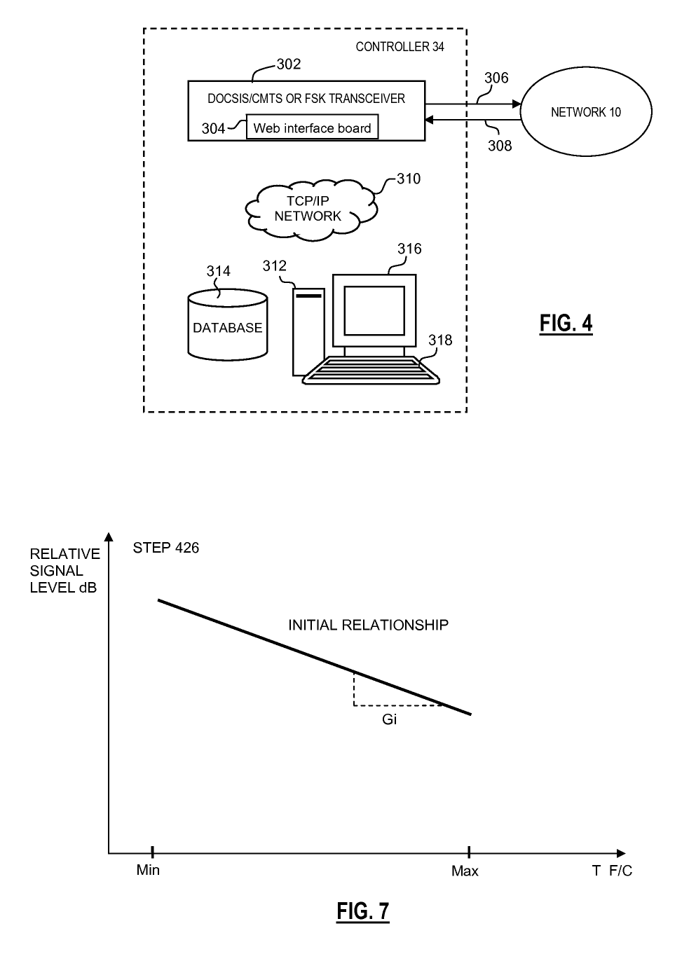

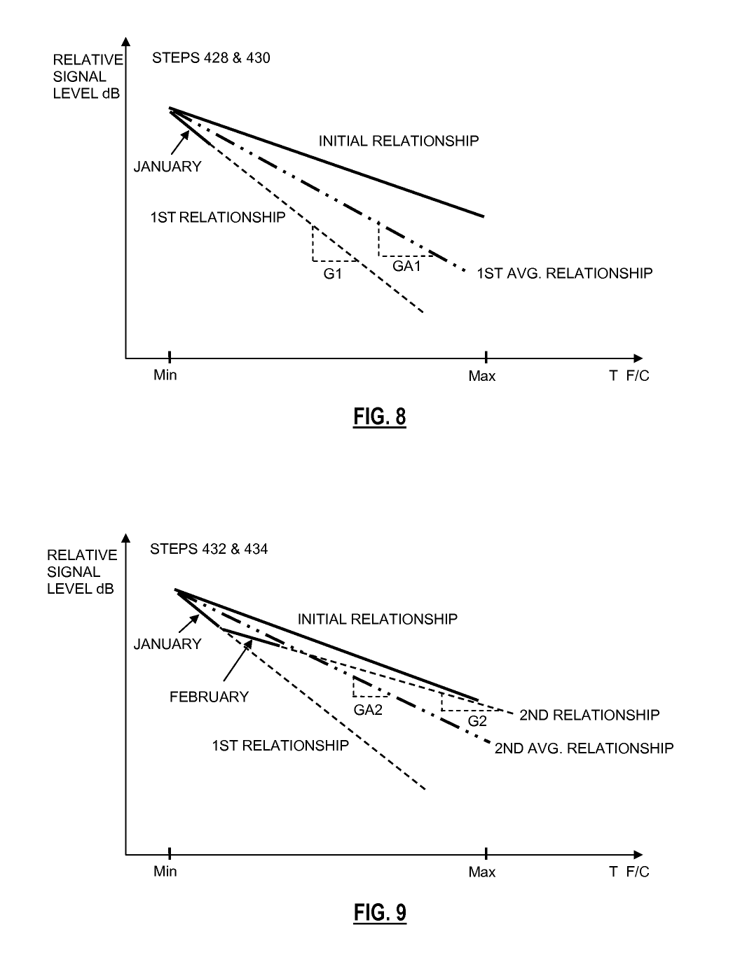

In one embodiment, the empirical relationship between signal level and temperature is derived by a method 420 outlined in FIG. 6 and illustrated further in FIGS. 7-10. Method 420 comprises steps 422 to 436. Step 422 concerns detecting, over a first time period, a plurality of signal level values of a signal at a monitoring point in a communications network. Step 424 concerns sensing a plurality of temperatures at the monitoring point in association with the detection of the plurality of signal level values. It is preferred that method steps 422 and 424 be performed by monitor 132 or monitor 232. Step 426 concerns starting with an initial relationship between signal level and temperature. It is preferred that the initial relationship be a straight line (having a negative gradient), representing change in signal level versus temperature. FIG. 7 shows an example of the initial relationship with a negative gradient Gi. Step 428 concerns determining a first relationship between signal level and temperature based on the signal level values and temperatures obtained over the first time period. FIG. 8 shows an example of the first relationship having a gradient G1. Signal level change versus temperature is plotted as a straight line for the month of January (solid line), based on the signal level values and temperatures obtained over January (i.e., the first time period). The January plot is extended as a straight line (dashed line) to complete the first relationship. Gradient G1 is established by the actual January data and January plot. Step 430 concerns averaging together the initial and the first relationships to create a first average relationship. FIG. 8 shows an example of the first average relationship having a gradient GA1. It is preferred that step 430 be performed by averaging together gradients Gi and G1 to produce gradient GA1.

Referring again to FIG. 6, step 432 concerns repeating steps 422 and 424 over a second time period and then repeating step 428 to determine a second relationship between signal level and temperature. The second relationship is determined based on the signal level values and temperatures obtained over the second time period. FIG. 9 shows an example of the second relationship having a gradient G2. Signal level change versus temperature is plotted as a straight line for the month of February (solid line), based on the signal level values and temperatures obtained over February (i.e., the second time period). The February plot is extended as a straight line (dashed line) to complete the second relationship. Gradient G2 is established by the actual February data and February plot. Step 434 concerns averaging together the second relationship and the first average relationship to create a second average relationship. FIG. 9 shows an example of the second average relationship having a gradient GA2. It is preferred that step 434 be performed by averaging together gradients G2 and GA1 to produce gradient GA2.

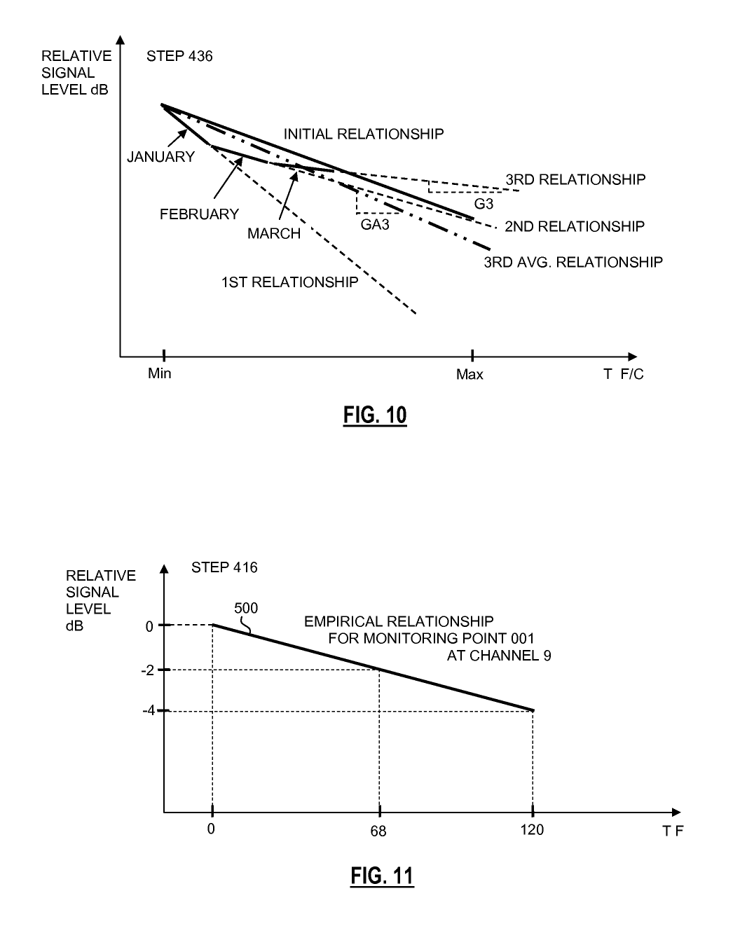

Referring again to FIG. 6, step 436 concerns successively repeating steps 432 and 434 for successive time periods, respectively, to determine successive relationships and create successive average relationships, respectively, until the empirical relationship is derived. For example, FIG. 10 shows a third relationship having a gradient G3. Signal level change versus temperature is plotted as a straight line for the month of March (solid line), based on signal level values and temperatures obtained over March (i.e., over a third time period). The March plot is extended to complete the third relationship. Gradient G3 is established by the actual March data and March plot. The third relationship is averaged together with second average relationship to create a third average relationship. FIG. 10 shows an example of the third average relationship having a gradient GA3. It is preferred that the averaging step be performed by averaging together gradients G3 and GA2 to produce gradient GA3. It is preferred that step 436 be repeated for each month of a calendar year (at least) in order to acquire data for at least most temperatures expected for the communications network. In the calendar year example, the twelfth average relationship becomes the empirical relationship used to adjust the alarm criterion (e.g., see FIG. 11). Of course, other time frames may be employed, e.g., 18 months or 24 months, and the time period for creating each iterative relationship is not limited to a whole month or a single month.

The empirical relationship may be derived in accordance with another method of the present invention, which comprises the steps of: (1) detecting a plurality of signal level values of the signal at the monitoring point, over a first time period (just as in step 422 of FIG. 6); (2) sensing a plurality of temperatures at the monitoring point in association with the detection of the plurality of signal level values (just as in step 424 of FIG. 6); (3) determining a first relationship between signal level and temperature based on the plurality of signal level values and the plurality of temperatures obtained over the first time period (just as in step 428 of FIG. 6); (4) successively repeating steps (1), (2) and (3) for successive time periods, respectively, to determine successive relationships; and (5) averaging together the first relationship and the successive relationships to derive the empirical relationship. The first and the successive relationships are determined in the same manner as the first, second and third relationships of FIGS. 8-10 are determined. But, rather than taking, for example, the second relationship and averaging it with a first average relationship, the individual relationships (i.e., the first and the successive relationships) are averaged together directly to produce a single average relationship, which becomes the empirical relationship.

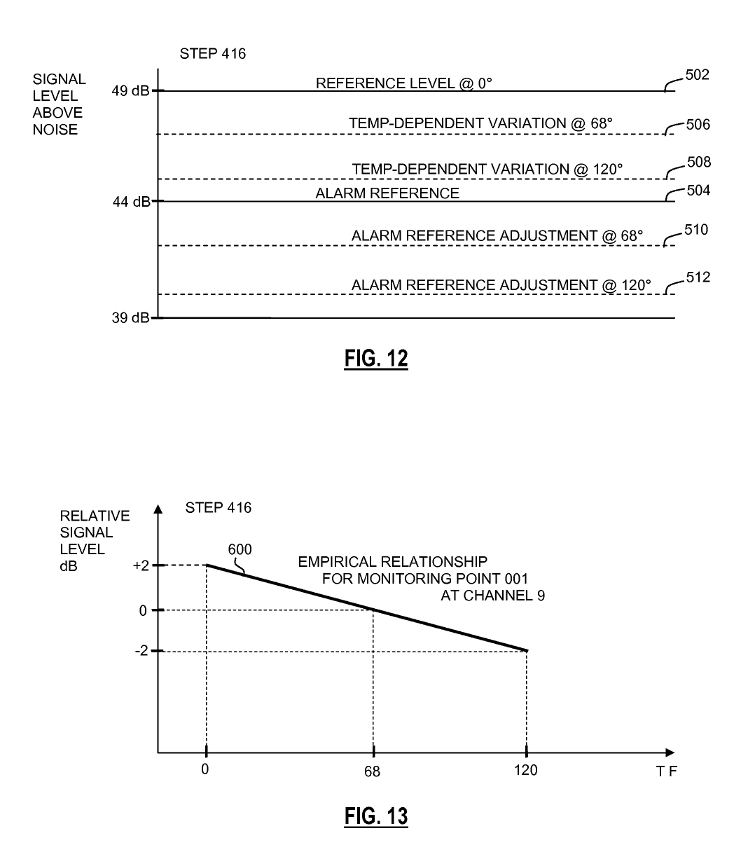

Referring now to FIG. 11, an empirical relationship 500 is shown, which was derived in accordance with method 420. Empirical relationship 500 is the twelfth average relationship produced in accordance with the example illustrated in FIGS. 7-10. As now understood, relationship 500 was derived at and for a particular monitoring point (e.g., 001, in FIG. 1) in network 10 and at a particular frequency band (e.g., television channel 9). Relationship 500 has a relative signal level set to zero at zero degrees F. Relationship 500 is used to perform step 416 of method 400 (FIG. 5). i.e., adjusting the alarm criterion in accordance with the empirical relationship. FIG. 12 illustrates one way in which step 416 is performed, i.e., by adjusting the alarm reference of the alarm criterion. In this example, a reference level 502 (FIG. 12) is specified to be 49 dB above the noise floor for channel 9, and the signal is assumed to be a quadrature amplitude modulated (QAM) digital television signal. In this example, reference level 502 is specified for zero degrees F. An alarm reference 504 is specified to be 5 dB below reference level 502, or 44 dB above noise. Empirical relationship 500 tells us that the signal level at monitoring point 001, at the channel 9 frequency, will drop 2 dB when the ambient temperature changes from 0 to 68 degrees. This drop is represented in FIG. 12 by a temperature-dependent variation line 506 (dashed). The signal level will drop 4 dB when the ambient temperature changes from 0 to 120 degrees, as represented by a temperature-dependent variation line 508. As can be seen from FIG. 12, the temperature-dependent variations of the signal level compress the margin or tolerance established by alarm reference 504. The margin is compressed to 3 dB at 68 degrees and to only 1 dB at 120 degrees. Thus, relatively small signal level variations (e.g., <5 dB) due to other causes will trigger an alarm. We call this a “false alarm,” because without the temperature-dependent variation the alarm would not have triggered. According to method step 416, alarm reference 504 is adjusted to 42 dB above noise, at 68 degrees, as represented by an alarm reference adjustment line 510 (dashed). Alarm reference 504 is adjusted to 40 dB above noise, at 120 degrees, as represented by an alarm reference adjustment line 512 (dashed).

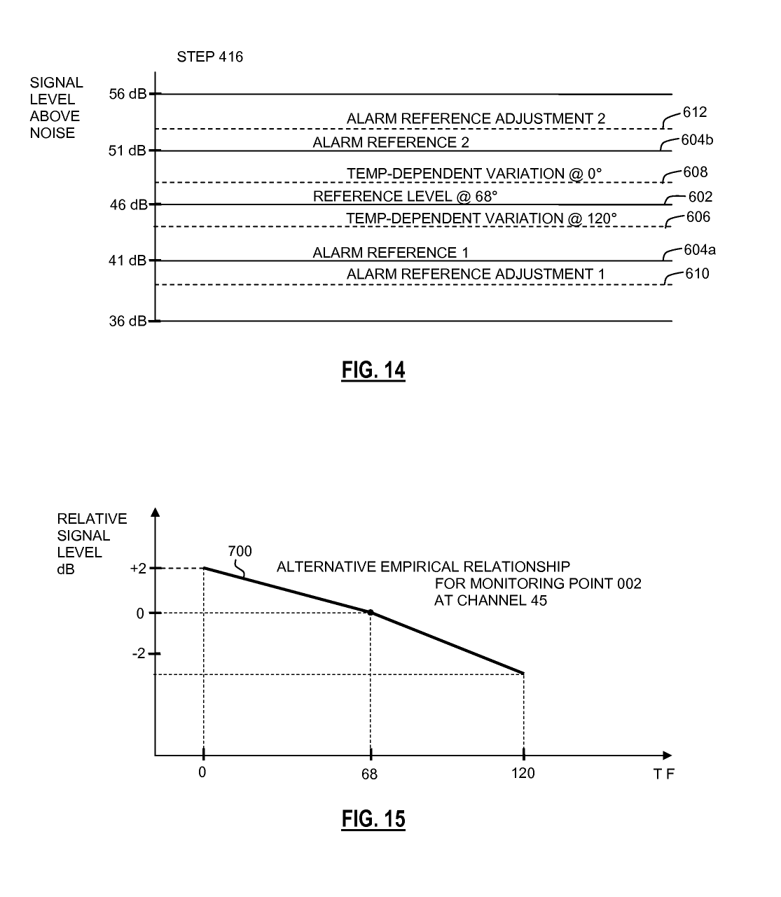

In FIG. 13, an empirical relationship 600 was derived at monitoring point 001 (FIG. 1), at the channel 9 frequency band. Relationship 600 is identical to relationship 500, except that the relative signal level is set to zero at 68 degrees instead of zero degrees. In this example, there are two alarm references (FIG. 14), either or both of which may be adjusted by performing method step 416. In FIG. 14, a reference level 602 is specified to be 46 dB above the noise floor at channel 9, at 68 degrees. Again, the signal is assumed to be a QAM digital television signal. An alarm reference 604a is specified to be 5 dB below reference level 602, or 41 dB above noise. An alarm reference 604b is specified to be 5 dB above reference level 602, or 51 dB above noise. According to empirical relationship 600 (FIG. 13), the signal level will drop 2 dB when the ambient temperature changes from 68 degrees to 120 degrees. This drop is represented in FIG. 14 by a temperature-dependent variation line 606 (dashed). Signal level will increase 2 dB when the ambient temperature changes from 68 degrees to 0 degrees, as represented in FIG. 14 by a temperature-dependent variation line 608. According to method step 416, alarm reference 604a is adjusted to 39 dB above noise, at 120 degrees, as represented by an alarm reference adjustment line 610 (dashed). Alarm reference 604b is adjusted to 53 dB above noise, at 0 degrees, as represented by an alarm reference adjustment line 612 (dashed).

Now referring to FIG. 15, there is shown an empirical relationship 700 derived in accordance with method 420. Relationship 700 is similar to relationship 600, except that relationship 700 is defined by two gradients. Relationship 700 was derived at and for a particular monitoring point (e.g., 002; FIG. 1) in network 10 and at a particular frequency band (e.g., television channel 45). Relationship 700 has a relative signal level set to zero at 68 degrees F. As shown in FIG. 15, relationship 700 is defined by a first gradient between zero degrees and 68 degrees and a second gradient between 68 degrees and 120 degrees. In this case, the two gradients reflect two different rates of change of cable loss in a coaxial cable. The relative signal level at zero degrees is +2 dB and the relative signal level at 120 degrees is −3 dB. FIG. 15 is presented to demonstrate that an empirical relationship, derived according to the present invention, may be characterized by more than one gradient.

The various functions of the monitoring systems and methods of present invention may be implemented in hardware, firmware, software, or a combination of these. Such functions include, but are not limited to: (1) determining values of a signal level parameter based on signal level values (e.g., step 408 of FIG. 5); (2) evaluating signal level parameter values relative to an alarm reference (e.g., step 410); (3) issuing alarms based on alarm criteria defined in terms of signal level parameter values and alarm references; (4) deriving empirical relationships between signal level and temperature based on detected signal level values and sensed temperatures (e.g., step 414); (5) adjusting alarm criteria in accordance with empirical relationships; (6) starting with an initial relationship between signal level and temperature (e.g., step 426 of FIG. 6); (7) determining successive relationships between signal level and temperature based on pluralities of signal level values and temperatures obtained over successive time periods (e.g., step 428); (8) averaging together the initial and first relationships to create a first average relationship (e.g., step 430); (9) determining successive relationships and creating successive average relationships to derive an empirical relationship (e.g., step 436); and (10) determining successive relationships and averaging them together to derive an empirical relationship. These functions and others described herein may be implemented entirely within monitors 32, 132, 232, entirely within controller 34, or partly within monitors 32, 132, 232 and partly within controller 34. Further, such functions may be implemented in, for example, one or more application specific integrated circuits (ASICs), digital signal processors (DSPs), field programmable gate arrays (FPGAs), programmable logic devices, micro-controllers, microprocessors, general purpose computers, special purpose computers, other electronic devices, or a combination of these devices (hereinafter “processor”).

The above-mentioned functions may be implemented, at least in part, in firmware, software, or other computer-executable instructions and stored on any suitable computer-readable media. Computer-executable instructions may cause a processor to perform the above-mentioned functions of the present invention. Computer-executable instructions include data structures, objects, programs, routines, or other program modules that may be accessed by a processor. The computer-readable media may be any available media accessable by a processor. Embodiments of the present invention may include one or more computer-readable media. In one example, the media may be memory units 152 and 252 shown in FIGS. 2 and 3, respectively, and/or hard drive memory inside or externally connected to server 312 (FIG. 4). Generally, computer-readable media include, but is not limited to, random-access memory (“RAM), read-only memory (“ROM), programmable read-only memory (“PROM), erasable programmable read-only memory (“EPROM), electrically erasable programmable read-only memory (“EEPROM”), compact disk read-only memory (“CD-ROM), or any other device or component that is capable of providing data or executable instructions accessible by a processor. Certain embodiments recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

While the preferred embodiments of the invention have been particularly described in the specification and illustrated in the drawing, it should be understood that the invention is not so limited. Many modifications, equivalents and adaptations of the invention will become apparent to those skilled in the art without departing from the spirit and scope of the invention, as defined in the appended claims.

What is claimed is:

1. A system for monitoring the signal level of a signal at a monitoring point in a communications network, comprising:
(a) a monitor, configured to be coupled to the monitoring point, including (i) a receiver tuned to receive the signal from the monitoring point, (ii) a detector for detecting values of signal level of the signal at the monitoring point, and (iii) a temperature sensor for sensing temperatures at the monitoring point in association with the detection of the signal level values;
(b) means for evaluating the detected signal level values relative to an alarm reference;
(c) means for issuing alarms based on an alarm criterion defined in terms of the signal level values and the alarm reference;
(d) means for deriving an empirical relationship between signal level and temperature from the signal level values detected and the temperatures sensed at the monitoring point; and
(e) means for adjusting the alarm criterion in accordance with the empirical relationship, such that temperature-dependent variations of the detected signal level values are substantially accounted for in issuing the alarms.

2. The system of claim 1, wherein said adjusting means adjusts the alarm reference.

3. The system of claim 1, wherein said adjusting means adjusts the signal level values.

4. The system of claim 1, wherein said evaluating means compares at least one of the detected signal level values to the alarm reference.

5. The system of claim 1, wherein said evaluating means compares an average of the detected signal level values to the alarm reference.

6. The system of claim 1, wherein the alarm criterion is selected from the group consisting of:
(a) at least one of the detected signal level values exceeds the alarm reference,
(b) an average of the detected signal level values exceeds the alarm reference,
(c) at least one of the detected signal level values attains the alarm reference,
(d) an average of the detected signal level values attains the alarm reference,
(e) at least one of the detected signal level values fails to exceed the alarm reference,
(f) an average of the detected signal level values fails to exceed the alarm reference,
(g) at least one of the detected signal level values fails to attain the alarm reference, and
(h) an average of the detected signal level values fails to attain the alarm reference.

7. The system of claim 1, further comprising means for revising the empirical relationship based on the signal level values detected and the temperatures sensed by said monitor.

8. A system for monitoring a signal level parameter of a signal at a monitoring point in a communications network, comprising:
(a) a monitor, configured to be coupled to the monitoring point, including (i) a receiver tuned to receive the signal from the monitoring point, (ii) a detector for detecting values of signal level of the signal at the monitoring point, and (iii) a temperature sensor for sensing temperatures at the monitoring point in association with the detection of the signal level values;
(b) means for determining values of the signal level parameter of the signal based on the detected signal level values;
(c) means for evaluating the signal level parameter values relative to an alarm reference;
(d) means for issuing alarms based on an alarm criterion defined in terms of the signal level parameter values and the alarm reference;
(e) means for deriving an empirical relationship between signal level and temperature based on the signal level values detected and the temperatures sensed at the monitoring point; and
(f) means for adjusting the alarm criterion in accordance with the empirical relationship, such that temperature-dependent variations of the signal level parameter values are substantially accounted for in issuing the alarms.

9. The system of claim 8, wherein the signal level parameter is signal level.

10. The system of claim 8, wherein said adjusting means adjusts the alarm reference.

11. The system of claim 8, further comprising means for revising the empirical relationship based on the signal level values detected and the temperatures sensed by said monitor.

12. A method of monitoring the signal level of a signal at a monitoring point in a communications network, comprising the steps of:
(a) receiving the signal from the monitoring point;
(b) detecting values of the signal level of the signal at the monitoring point;
(c) sensing temperatures at the monitoring point in association with the detection of the signal level values;
(d) evaluating the signal level values relative to an alarm reference;
(e) issuing alarms based on a criterion defined in terms of the signal level values and the alarm reference;
(f) deriving an empirical relationship between signal level and temperature based on the signal level values detected in step (b) and the temperatures sensed in step (c); and
(g) adjusting the criterion in accordance with the empirical relationship, such that temperature-dependent variations of the signal level values are substantially accounted for in issuing the alarms.

13. The method of claim 12, wherein step (g) includes adjusting the alarm reference.

14. The method of claim 12, wherein step (g) includes adjusting the signal level values.

15. The method of claim 12, wherein:
step (b) includes detecting a plurality of signal level values of the signal at the monitoring point, over a first time period;
step (c) includes sensing a plurality of temperatures at the monitoring point in association with the detection of the plurality of signal level values; and
step (f) includes—
(i) starting with an initial relationship between signal level and temperature,
(ii) determining a first relationship between signal level and temperature based on the plurality of signal level values and the plurality of temperatures obtained over the first time period,
(iii) averaging together the initial relationship and the first relationship to create a first average relationship,
(iv) repeating steps (b) and (c) over a second time period and repeating sub-step (ii) of step (f) to determine a second relationship between signal level and temperature based on the plurality of signal level values and the plurality of temperatures obtained over the second time period,
(v) averaging together the second relationship and the first average relationship to create a second average relationship, and
(vi) successively repeating sub-steps (iv) and (v) of step (f) for successive time periods, respectively, to determine successive relationships and create successive average relationships, respectively, until the empirical relationship is derived.

16. The method of claim 15, wherein:
the initial and the first relationships are each defined by a gradient, and sub-step (iii) of step (g) includes averaging together the gradients of the initial and the first relationships to create the first average relationship;
the second relationship and the first average relationship are each defined by a gradient, and sub-step (v) of step (g) includes averaging together the gradients of the second relationship and first average relationship to create the second average relationship; and
the successive relationships, the second average relationship, and the successive average relationships are each defined by a gradient, and sub-step (vi) of step (g) includes averaging together the gradients of the successive relationships with the gradients of the second average relationship and the successive average relationships, respectively, to create the empirical relationship having an empirical gradient.

17. The method of claim 12, wherein:
step (b) includes detecting a plurality of signal level values of the signal at the monitoring point, over a first time period;
step (c) includes sensing a plurality of temperatures at the monitoring point in association with the detection of the plurality of signal level values; and
step (g) includes—
(i) determining a first relationship between signal level and temperature based on the plurality of signal level values and the plurality of temperatures obtained over the first time period,
(ii) successively repeating steps (b) and (c) and sub-step (i) of step (g) for successive time periods, respectively, to determine successive relationships, and
(iii) averaging together the first relationship and the successive relationships to derive the empirical relationship.

18. The method of claim 17, wherein the first relationship and the successive relationships are each defined by a gradient, and sub-step (iii) of step (g) includes averaging together the gradients of the first and the successive relationships to create the empirical relationship having an empirical gradient.

19. A method of monitoring a signal level parameter of a signal at a monitoring point in a communications network, comprising the steps of:
(a) receiving the signal from the monitoring point;
(b) detecting values of signal level of the signal at the monitoring point;
(c) sensing temperatures at the monitoring point in association with the detection of the signal level values;
(d) determining values of the signal level parameter based on the signal level values;
(e) evaluating the values of the signal level parameter relative to an alarm reference;
(f) issuing alarms based on a criterion defined in terms of the signal level parameter values and the alarm reference;
(g) deriving an empirical relationship between signal level and temperature based on the signal level values detected in step (b) and the temperatures sensed in step (c); and
(h) adjusting the criterion in accordance with the empirical relationship, such that temperature-dependent variations of the signal level parameter values are substantially accounted for in issuing the alarms.

20. The method of claim 19, wherein step (h) includes adjusting the alarm reference.

21. The method of claim 19, wherein step (h) includes adjusting the signal level parameter values.

22. The method of claim 19, wherein:
step (b) includes detecting a plurality of signal level values of the signal at the monitoring point, over a first time period;
step (c) includes sensing a plurality of temperatures at the monitoring point in association with the detection of the plurality of signal level values; and
step (g) includes—
(i) starting with an initial relationship between signal level and temperature,
(ii) determining a first relationship between signal level and temperature based on the plurality of signal level values and the plurality of temperatures obtained over the first time period,
(iii) averaging together the initial relationship and the first relationship to create a first average relationship,
(iv) repeating steps (b) and (c) over a second time period and repeating sub-step (ii) of step (g) to determine a second relationship between signal level and temperature based on the plurality of signal level values and the plurality of temperatures obtained over the second time period,
(v) averaging together the second relationship and the first average relationship to create a second average relationship, and
(vi) successively repeating sub-steps (iv) and (v) of step (g) for successive time periods, respectively, to determine successive relationships and create successive average relationships, respectively, until the empirical relationship is derived.

23. The method of claim 22, wherein:
the initial and the first relationships are each defined by a gradient, and sub-step (iii) of step (g) includes averaging together the gradients of the initial and the first relationships to create the first average relationship:
the second relationship and the first average relationship are each defined by a gradient, and sub-step (v) of step (g) includes averaging together the gradients of the second relationship and first average relationship to create the second average relationship; and
the successive relationships, the second average relationship, and the successive average relationships are each defined by a gradient, and sub-step (vi) of step (g) includes averaging together the gradients of the successive relationships with the gradients of the second average relationship and the successive average relationships, respectively, to create the empirical relationship having an empirical gradient.

24. The method of claim 19, wherein:
step (b) includes detecting a plurality of signal level values of the signal at the monitoring point, over a first time period;
step (c) includes sensing a plurality of temperatures at the monitoring point in association with the detection of the plurality of signal level values; and
step (g) includes—
(i) determining a first relationship between signal level and temperature based on the plurality of signal level values and the plurality of temperatures obtained over the first time period,
(ii) successively repeating steps (b) and (c) and sub-step (i) of step (g) for successive time periods, respectively, to determine successive relationships, and
(iii) averaging together the first relationship and the successive relationships to derive the empirical relationship.

25. The method of claim 24, wherein the first relationship and the successive relationships are each defined by a gradient, and sub-step (iii) of step (g) includes averaging together the gradients of the first and the successive relationships to create the empirical relationship having an empirical gradient.
